(19) United States
(12) Patent Application Publication
(10) Pub. No.: US 2008/0285542 A1
(43) Pub. Date: Nov. 20, 2008

(54) LOCATION BASED PRESENCE GROUPS

(75) Inventor: JACK JACHNER, LEXINGTON, MA (US)

Correspondence Address: GARLICK, HARRISON & MARKISON (ALU), P.O. BOX 160727, AUSTIN, TX, 78716-0727, US

(73) Assignee: ALCATEL LUCENT, Paris (FR)

(21) Appl. No.: 12/049,623

(22) Filed: Mar. 17, 2008

Related U.S. Application Data
(60) Provisional application No. 60/938,959, filed on May 18, 2007.

(51) Int. Cl. H04L 12/28

(52) U.S. Cl. 370/351

(57) ABSTRACT

A presence system creates location based presence groups for presentities based on the current geographical location of the presentities. The presence system calculates respective distances between the presentities and forms respective location based presence groups for the presentities by including within each location based presence group those presentities whose calculated distance from the respective presentity is less than a configurable proximity metric. Each presentity is then provided with the presence information of all of the presentities within their location based presence group.

### CROSS-REFERENCE TO RELATED APPLICATIONS

This U.S. Nonprovisional application for patent claims the benefit of the filing date of U.S. Provisional Patent Application entitled, Location Based Presence Groups, Attorney Docket No. 800903, having Ser. No. 60/938,959, filed on May 18, 2007, which is incorporated herein by reference for all purposes.

### BACKGROUND OF THE INVENTION

1. Technical Field of the Invention

The present invention relates in general to a presence-based communication system, and in particular, to presence groups within presence systems.

2. Description of Related Art

The ability for users to monitor each other's presence is a feature offered in connection with many applications that support network telephony. For example, instant messaging (“IM”) applications have a buddy list or contact list feature, in which a user of the application can determine whether select users or objects are available for engaging in communication. The data retrieved and returned to the contact list, e.g., “John OFFLINE” or “Susan ONLINE”, is referred to as “presence information,” and is generally maintained by a presence server in the data network, which is often a dedicated server. Typically, the presence server supports network telephony protocols such as Session Initiation Protocol (SIP).

Users can register their communications devices with the presence server in order to have their presence maintained and to allow various programs on the network to facilitate network telephony services. For example, a first user wishing to detect the presence of a second user may do so by “subscribing” with the presence server, such as via a SIP SUBSCRIBE message. The presence server intermediates between the first user (also known as a “watcher” or “subscriber”) and the second user (also known as a “presentity”) to facilitate the communication of the presentity's presence information to the watcher.

There are many situations where it would be desirable for presentities to organize into groups that are proximately located within some distance criterion. For example, occupants of an automobile on a road or highway may want to communicate with occupants of other automobiles in the immediate area. Likewise, people at an event, gathering, show, religious service, movie, restaurant, dance club, class, amusement park, or on mass transit (e.g., bus, train, plane, etc.) may want to communicate with other people or with nearby services, with which they do not share prior acquaintance, but simply by virtue of their proximity.

However, building presence groups (buddy lists) is a time consuming and hence fairly static activity, similar to populating email address lists or phone directories. There is currently no mechanism for automatically generating presence groups based on proximity. In addition, buddies typically need to be individually authorized by the presentity, which presents a barrier to enabling dynamic updates to presence groups based on proximity. Therefore, there is a need for an enhancement to existing presence systems to integrate location based information in order to dynamically update presentity's presence groups based on proximity, while respecting privacy and security considerations.

### SUMMARY OF THE INVENTION

Embodiments of the present invention provide a method for implementing location based presence groups within a presence system. The method includes receiving presence information for a plurality of presentities, in which the presence information includes contact information for and availability in one or more media types of the presentities and location information identifying a respective current geographical location of each of the presentities. The method further includes calculating respective distances between the presentities using the location information, forming a location based presence group for a watcher of the presentities, in which the location based presence group includes the presentities whose calculated distance from the watcher is less than a configurable proximity metric and providing the watcher with the presence information of the presentities within the location based presence group.

In one embodiment, the presentities that have subscribed to a location based presence service are identified and the location based presence group is formed from those presentities that subscribed to the location based presence service. In a further embodiment, at least one of the presentities is prompted to subscribe to the location based presence service based on the current geographical location of that presentity.

In another embodiment, the presence information of the presentities is filtered before providing the filtered presence information to the watcher. For example, in one embodiment, the presence information is filtered in accordance with preference information associated with the watcher, in which the preference information indicates a portion of the presence information associated with the presentities that the watcher would like to receive. In another embodiment, the presence information is filtered in accordance with preference information associated with at least one of the presentities, in which the preference information indicates a portion of the presence information associated with the presentity that the watcher can receive.

In still another embodiment, a partial location based presence group is provided to the watcher. The partial location based presence group represents changes to the location based presence group based on a previous location based presence group. For example, the changes can include added ones and removed ones of the presentities. In yet another embodiment, the configurable proximity metric is determined based on the current geographic location of the watcher or the preferences of the watcher.

Embodiments of the present invention further provide a presence server operable to maintain presence information for a plurality of presentities, in which the presence information includes contact information for and availability in one or more media types of the presentities and location information identifying a respective current geographical location of each of the presentities. A proximity presence group application operates to calculate respective distances between the presentities, using the location information, and form a location based presence group for a watcher of the presentities. The location based presence group includes the presentities whose calculated distance from the watcher is less than a configurable proximity metric. The presence server further operates to provide the presence information of the presentities within the location based presence group to the watcher.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary communication system providing location based presence groups for presentities, in accordance with embodiments of the present invention;

FIG. 2 illustrates an exemplary presence system capable of forming location based presence groups and communicating presence information of location based presence groups, in accordance with embodiments of the present invention;

FIG. 3 illustrates an exemplary proximity presence group application for forming the location based presence groups of the present invention;

FIG. 4 illustrates an exemplary view of presence information of a location based presence group, in accordance with embodiments of the present invention; and

FIG. 5 is a flowchart illustrating an exemplary process for implementing location based presence groups, in accordance with embodiments of the present invention.

### DETAILED DESCRIPTION OF THE DRAWINGS

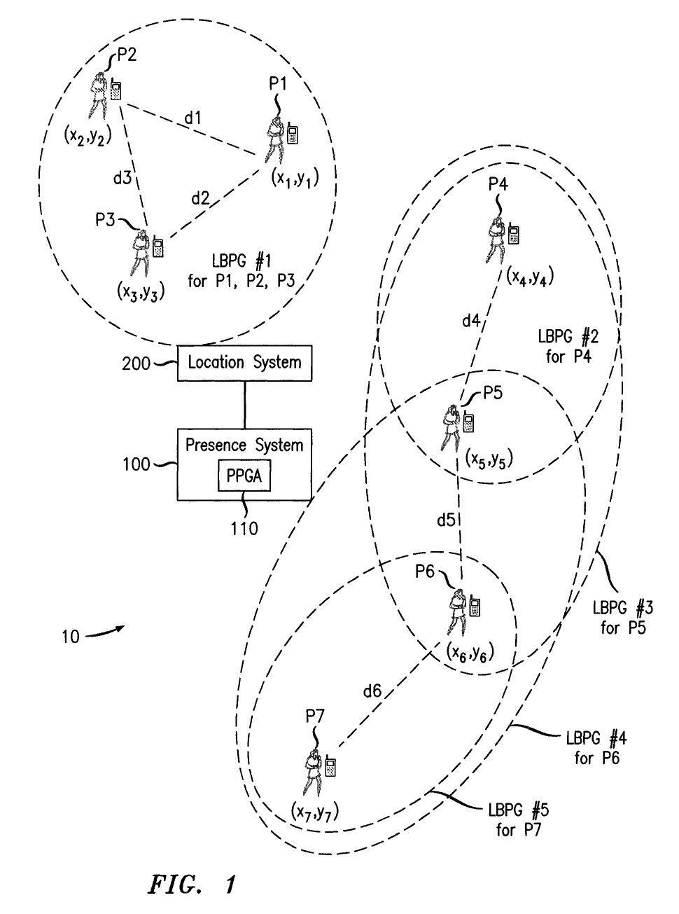

FIG. 1 illustrates an exemplary communications system 10 providing location based presence groups (LBPG), in accordance with embodiments of the present invention. The communications system 10 includes a Location System 200 and a Presence System 100, linked in function by a Proximity Presence Group Application (PPGA) 110. The Presence System 100 maintains presence information for a plurality of presentities and provides that presence information to watchers of the presentities. In accordance with embodiments of the present invention, the term “watcher” refers to a presentity who has subscribed to a location based presence group service in order to receive the presence information of presentities that are proximately located to that watcher.

The Location System (LS) 200 operates to determine the location of each user (presentity) that has authorized their participation in the location based presence group service. More specifically, the LS 200 determines the geographical location (e.g., latitude and longitude) of a presentity, and communicates that location to the PPGA 110. For example, the LS 200 can transmit the location information to the PPGA 110 as part of the presentity's presence information. The LS 200 refers to any type of location system, including, but not limited to, a Global Positioning System (GPS) receiver coupled to or integrated with a user terminal or a network-based location system, such as a Time of Arrival, Angle of Arrival or other network-based positioning method.

The PPGA 110 computes the distance between each presentity pair, and for each presentity, compiles a list of other presentities that are within a configurable proximity metric for that presentity to form a location based presence group (LBPG) for that presentity. The proximity metric can be configured by the presentity or configured based on the current location of the presentity. For example, if the location of the presentity indicates that the presentity is within a sports arena, the proximity metric can be configured by the PPGA 110 to include the entire sports arena and parking lots around the sports arena.

Once the members of the LBPG for a particular presentity/watcher are identified, the PPGA 110 then communicates this LBPG to the Presence System 100, which in turn, provides the LBPG to the presentity/watcher. In addition, the Presence System 100 provides the presence information associated with each presentity within the LBPG to the presentity/watcher for use by the presentity/watcher in establishing communication with one or more of the presentities within the LBPG. For example, the presence information provided to the presentity/watcher can include the availability of each presentity within the LBPG in one or more media types (e.g., voice, text, e-mail, multi-media, etc.) and contact information for the presentities within the LBPG.

In one embodiment, the Presence System 100 receives the LBPG for each authorized presentity on a regular basis, and in case of changes to the LBPG, communicates either the entire LBPG or a partial version of the LBPG representing only updates (e.g., adds and deletes) to each presentity. The presentity can then subscribe to any new presentities in the LBPG, and un-subscribe from any presentities deleted from the LBPG. The PPGA 110 may be resident within a presence server or other network node within the presence system and may be implemented in hardware, software, firmware or any combination thereof. The PPGA 110 may further be centralized within a single node or distributed throughout a network.

In the example shown in FIG. 1, seven presentities, P1-P7 are present, each at a different geographical location, represented by coordinates (x, y). In addition, five different LBPG's are shown, each including one or more of the presentities P1-P7, and each associated with one or more of the presentities. The first LBPG (LBPG#1) includes presentities P1, P2 and P3, and is associated with each of presentities P1, P2 and P3. Thus, each of the presentities P1, P2 and P3 is within the configurable proximity metric for the other presentities P1, P2 and P3. For example, the distance d1 between the location (x1, y1) of presentity P1 and the location (x2, y2) of presentity P2 is within the proximity metric for both P1 and P2, the distance d2 between the location (x1, y1) of presentity P1 and the location (x3, y3) of presentity P3 is within the proximity metric for both P1 and P3 and the distance d3 between the location (x2, y2) of presentity P2 and the location (x3, y3) of presentity P3 is within the proximity metric for both P2 and P3. As a result, the presentities within each of the respective location based presence groups for P1, P2 and P3 are the same. Therefore, only a single location based presence group, LBPG #1, is shown.

The second LBPG (LBPG#2) is associated with presentity P4 and includes presentities P4 and P5. Thus, the distance d4 between the location (x4, y4) of presentity P4 and the location (x5, y5) of presentity P5 is within the configurable proximity metric associated with P4. The distance between the location (x4, y4) of presentity P4 and the location of any of the other presentities P1-P3, P6 or P7 is outside of the proximity metric for P4, and therefore, only presentity P5 is included within LBPG#2 for P4. The third LBPG (LBPG#3) is associated with presentity P5 and includes presentities P4, P5 and P6. Thus, the respective distances d4 and d5 between presentity P5 and presentities P4 and P6 are within the configurable proximity metric associated with P5. As a result, presentity P5 has both presentity P4 and presentity P6 within his/her LBPG, while presentity P4 only has presentity P5 within his/her LBPG.

Likewise, the fourth LBPG (LBPG#4) is associated with presentity P6 and includes presentities P5, P6 and P7, while the fifth LBPG (LBPG#5) is associated with presentity P7 and includes only presentities P6 and P7. Thus, presentity P6 has both presentity P5 and presentity P7 within his/her LBPG, and presentity P7 has only presentity P6 within his/her LBPG. Therefore, presentity P7 will be able to communicate with presentity P6, but not with presentity P5, while presentity P6 will be able to communicate with both presentities P5 and P7.

As the location of each of the presentities changes, so does the LBPG for that presentity. For example, if presentity P4 were to move into the area of LBPG#1, such that presentity P4 is within the proximity metric for presentities P1, P2 and P3, presentity P4 would be added to LBPG#1 and removed from LBPG#3. Thus, LBPG#2 would change to include only presentities P1, P2 and P3. Dynamically updating the groups of people with which a presentity/watcher shares presence and a means to engage in communication using various media types (e.g., voice, text, e-mail, multimedia, etc.) increases the social interaction distance from the people within earshot to a wider radius that is still motivated by the relative proximity and by the potential to share communication around a common experience.

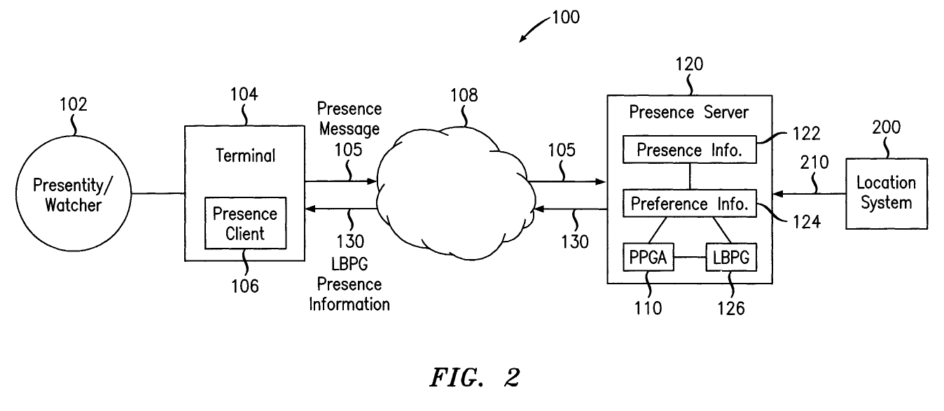

Referring now to FIG. 2, there is illustrated an exemplary presence system 100 capable of implementing various embodiments of the present invention. The presence system 100 includes one or more presentity/watcher's (one of which is shown for convenience) 102, one or more presence clients 106 associated with each of the presentity/watcher's (again, only one of which is shown for convenience) and a presence server 120. The presence server 120 includes the PPGA 110 and maintains presence information 122 and preference information 124 for a plurality of presentities.

The presentity/watcher 102 provides presence information 122 indicating the presentity/watcher's presence state to the presence system 100 via the presence clients 106 associated with the presentity/watcher 102. Each presence client 106 represents an application that independently generates a component of the overall presence information for a presentity/watcher 102. For example, as shown in FIG. 2, the presence client 106 is an application (e.g., an instant messaging application, electronic mail application, calendar application, text message application, telephony application, voice application or multi-media application) running on a user-operated physical communications terminal 104 capable of sending and/or receiving communications over a communications network 108. Examples of such communications terminals 104 include, but are not limited to, a desktop phone, a laptop computer, a personal computer, a cell phone, a PDA and other user-operated communications device. The communications network 108 represents any type of network over which media (e.g., circuit-switched or packet-switched voice or data) may be sent. For example, the communications network 108 can include the Public Switched Telephone Network (PSTN), Public Land Mobile Network (PLMN), one or more private local area networks (LANs), the Internet and/or any other type or combination of networks.

Although not shown in FIG. 2, the communications terminal 104 may also include a graphical user interface for displaying real-time presence information on a display thereof in the form of icons and/or text strings. In addition, the graphical user interface may also include buttons that enable the presentity/watcher 102 or other user to invoke an action, such as updating the presence information 122 of the presentity/watcher 102 or initiating an instant message (IM), text message or voice communication session with another presentity.

Therefore, in accordance with embodiments of the present invention, the presence client 106 associated with the presentity/watcher 102 is operable to both provide presence information 122 associated with the presentity/watcher 102 to the presence server 120 and to retrieve the presence information 122 of other presentities to whom the presentity/watcher 102 has subscribed. For example, the presence client 106 can receive the presence information of one or more presentities within a location based presence group (LBPG) 126 associated with the presentity/watcher 102. Upon receiving such presence information 122, the presence client is further able to display the presence information 122 to the presentity/watcher 102.

Typically, the presence client 106 generates and transmits a presence message 105 containing updated presence information 122 to the presence server 120 when a change in presence state of the presentity/watcher 102 occurs. Examples of changes in presence state include, but are not limited to, turning on and off the communications terminal 104, modifying the registration from the communications terminal, changing the instant messaging status on the communications terminal, operating the communications terminal (e.g., placing a phone call, receiving a phone call, generating an e-mail, etc.) and requesting or initiating a service (e.g., initiating Internet access, activating voice mail, etc.) from the communications terminal. As an example, when the presentity/watcher 102 initiates or answers a phone call on the communications terminal 104, the presence client 106 associated with the communications terminal 104 updates the presentity's presence state with the presence server 120 to “On the Phone.”

The presence server 120 aggregates the presence information from each of the sources (e.g., presence clients of the presentity/watcher and other presentities) and maintains the current complete presence information for the presentity/watcher 102 and other presentities. For example, the presence information 122 for a particular presentity can indicate the availability of that presentity, the current activity of that presentity, the local time where that presentity is located, the current status of the active communications devices and/or applications running on active communications devices and the current status of any services/applications associated with that presentity. In addition, in accordance with embodiments of the present invention, the presence information 122 for a particular presentity may also include the current location of the presentity 210. This location information 210 can be provided to the presence server 120 from a Location System 200 as part of the presence information for that presentity, as described above in connection with FIG. 1.

Based on the current location of the presentity/watcher 102 and the current location of other presentities, the PPGA 110 within the presence server 120 computes the respective distances between the presentity/watcher 102 and the other presentities for whom the presence server 120 maintains presence information 122, and compiles a list of other presentities that are within a configurable proximity metric for the presentity/watcher 102 to form the location based presence group (LBPG) 126 for that presentity. The presence server 120 accesses the presence information 122 of the presentities within the LBPG 126 associated with the presentity/watcher 102 to create LBPG presence information 130 for the presentity/watcher 102. The presence server provides the LBPG presence information 130 to the presence client 106 associated with the presentity/watcher 102 to enable the presentity/watcher 102 to view the detailed presence state of each presentity within the LBPG. For example, the detailed presence state information can indicate whether the presentity is currently available to engage in a communications session in one or more media types (e.g., text, voice and/or multimedia) on one or more communications terminals.

As described above, the presence server 120 further stores preference information 124 for the presentities within the presence system 100. For example, the preference information 124 can include both presentity preference information (e.g., privacy filters) set by the presentity 102 for each watcher and watcher preference information (e.g., watcher filters) set by each watcher for presentities. As such, the preference information 124 operates to filter the presence information 122 of a particular presentity as provided to a particular watcher to accommodate privacy concerns, prioritization requirements, viewing requirements, administrator policies and security considerations. Using the example shown in FIG. 2, the presence server 120 can access the preference information 124 of the presentity/watcher 102 and the preference information 124 of the presentities within the LBPG 126 for the presentity/watcher 102 to generate the LBPG presence information 130 that is provided to the presence client 106 of the presentity/watcher 102.

In order to provide presence services to the presentity/watcher 102 and other presentities, the presence system 100 uses a presence protocol, such as the Session Initiation Protocol (SIP), as described in J. Rosenberg, et al., “SIP: Session Initiation Protocol” RFC: 3261, June 2002 and in A. Roach, et al., “Session Initiation Protocol (SIP)—Specific Event Notification,” RFC: 3265, June 2002, each of which are hereby incorporated by reference. SIP is an application-layer control protocol used to create, modify and terminate communication (voice, text and/or multimedia) sessions. SIP can be used with other protocols, such as the Real-time Transport Protocol (RTP), the Real-Time Streaming Protocol (RTSP), the Session Description Protocol (SDP), the International Telecommunication Union—Telecommunications (“ITU-T”) H.263 standard (video CODEC), the G.711 and G.729 standards (audio CODECs), and other or additional standards or protocols. As will be appreciated, other or additional protocols and configurations may be used.

SIP networks are capable of routing requests from any user on the network to the server that maintains the registration state for a user. Thus, SIP networks enable the presentity/watcher 102 to transmit a SUBSCRIBE request for presence information relating to a particular presentity within the LBPG 126 to the presence server 120 that maintains the presence information for that presentity. In operation, the presence server 120 may be co-located with the SIP proxy/registrar for efficiency purposes. Additional details about presence and presence modeling are set forth in the Internet Engineering Task Force (IETF) Request for Comment (RFC) 2778 entitled “A model for Presence and Instant Messaging,” dated February 2002; RFC 2779 entitled “Instant Messaging/Presence Protocol Requirements,” dated February 2002; and Internet-Draft identified as <<draft-schulzrinne-simple-rpids-01.ps>> and entitled “RPIDS—Rich Presence Information Data Format for Presence Based on the Session Initiation Protocol (SIP),” dated Feb. 18, 2003, which are incorporated herein by reference.

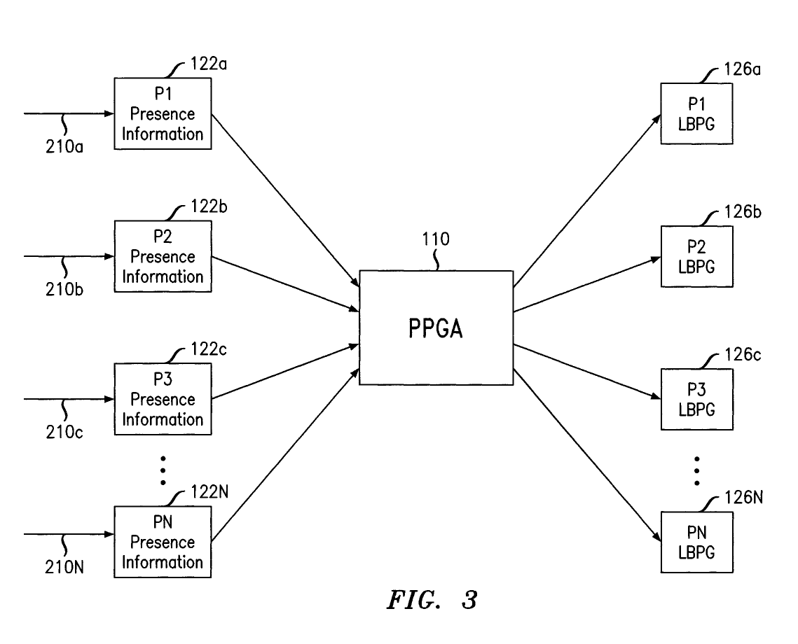

A more detailed description of the operation of the PPGA 110 follows with reference to FIG. 3. In FIG. 3, the PPGA 110 takes as input the presence information of a plurality of presentities P1, P2, P3, P4 . . . PN and produces as output respective location based presence groups (LBPG) for each of the presentities. The presence information for presentity P1 is designated by box 122a and includes location information 210a identifying the current location of presentity P1, the presence information for presentity P2 is designated by box 122b and includes location information 210b identifying the current location of presentity P2, the presence information for presentity P3 is designated by box 122c and includes location information 210c identifying the current location of presentity P3 and the presence information for presentity PN is designated by box 122N and includes location information 210N identifying the current location of presentity PN.

The PPGA 110 extracts the location information 210a . . . 210N and a proximity metric from the presence information 122a . . . 122N of each of the presentities P1 . . . PN and uses the location information 210a . . . 210N and associated proximity metrics to generate each of the LBPG's 126a . . . 126N. In particular, the PPGA 110 calculates the distance between each of the presentities, and for each of the presentities, compares the proximity metric for that presentity to the distances from that presentity to the other presentities, to determine which presentities are within the proximity metric for that presentity. The PPGA 110 then includes those presentities that are within the proximity metric for a particular presentity within the LBPG for that presentity. The result is a plurality of LBPG's 126a . . . 126N, each associated with a particular presentity, and each including the identities of the other presentities that are within the proximity metric to that particular presentity.

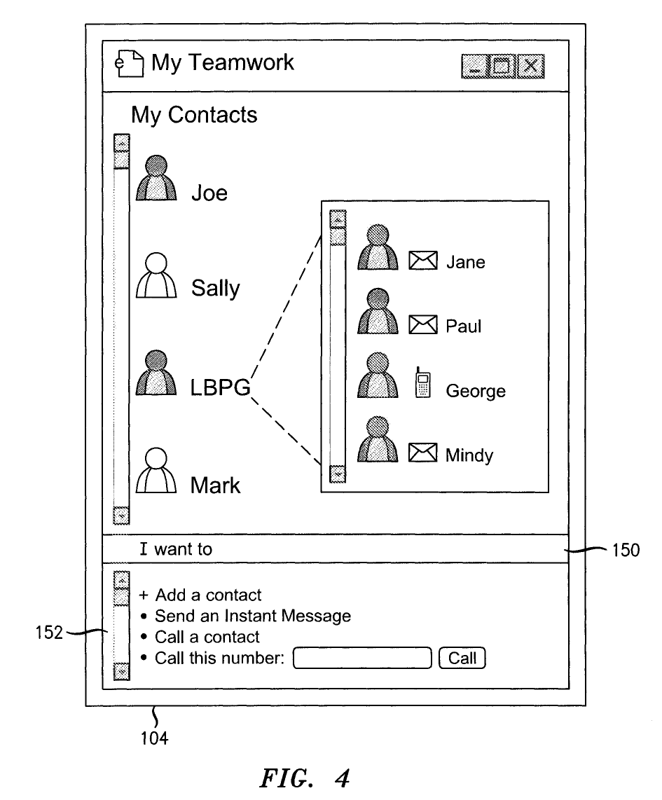

FIG. 4 illustrates a communications terminal 104 associated with a presentity/watcher (user) that includes a display 150 for viewing and managing the presence information 122 of presentities, including the presence state of one or more presentities within one or more location based presence groups (LBPGs) associated with the presentity, in accordance with embodiments of the present invention. The presence information of other presentities is displayed on the display 150 within a dedicated graphical user interface 152 provided by a presence client (not shown) running on the communications terminal 104. From the graphical user interface 152, the presence client enables the user of the communications terminal 104 to view the presence information displayed thereon and/or invoke an action to communicate with one or more of the presentities based on the displayed presence information of those presentities.

For example, as shown in FIG. 4, a location based presence group (LBPG) is included within the list of contacts for the user. Within the LBPG are at least four presentities: Jane, Paul, George and Mindy. Thus, Jane, Paul, George and Mindy are located within the proximity metric for the user associated with the communications terminal 104. The presence information of the presentities within the LBPG is graphically displayed to the user in the form of icons and text. In particular, the availability of each presentity and the particular media types that each presentity prefers to communicate with are displayed as icons next to the names of each presentity. For example, Jane, Paul, George and Mindy are all available (as indicated by the darkened person icon), but Jane, Paul and Mindy prefer to communicate via e-mail (as indicated by the e-mail icon), while George prefers to communicate by phone (as indicated by the phone icon).

In one embodiment, the user can initiate a communication session with one or more of the presentities in the LBPG by selecting them individually and establishing a communication session with them in their preferred media type. In another embodiment, the user can initiate a communication session with all of the presentities within the LBPG by selecting the LBPG as the contact with which to establish the communication session, and then the GUI 152 can prompt the user to select a particular media type to use for the communication session. In yet another embodiment, the user can invoke a particular action (e.g., send an instant message, call a contact, etc.) and then select one or more of the presentities individually within the LBPG and/or the LBPG as a whole to initiate the communication session.

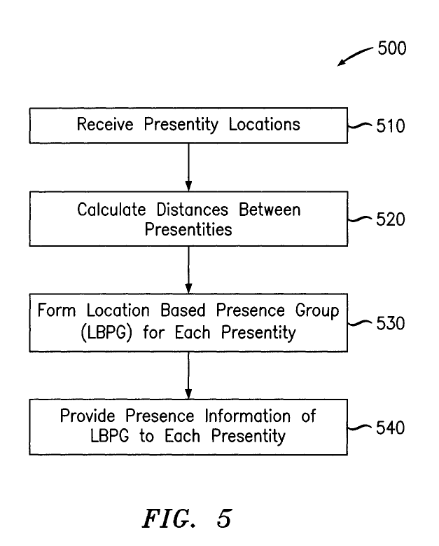

FIG. 5 is a flowchart illustrating an exemplary process 500 for implementing location based presence groups, in accordance with embodiments of the present invention. Initially, at block 510, the current geographical locations of a plurality of presentities are determined and received at a presence system. At block 520, the respective distances between each of the presentities are calculated, and at block 530, a respective location based presence group (LBPG) for each presentity is formed based on the calculated distances. For example, for each of the presentities, a proximity metric for that presentity is compared to the distances from that presentity to the other presentities to determine which presentities are within the proximity metric for that presentity. The LBPG for that presentity is then formed of those presentities that are within the proximity metric for that presentity. Once the LBPG's have been formed, at block 540, the presence information of all of the presentities within each of the LBPG's are provided to the respective presentities associated with the LBPG's to enable the presentities to engage in communication sessions with other proximately located presentities.

As will be recognized by those skilled in the art, the innovative concepts described in the present application can be modified and varied over a wide range of applications. Accordingly, the scope of patents subject matter should not be limited to any of the specific exemplary teachings discussed, but is instead defined by the following claims.

I claim:

1. A method for implementing location based presence groups within a presence system, comprising:
receiving presence information for a plurality of presentities, said presence information including contact information for and availability in one or more media types of the presentities and location information identifying a respective current geographical location of each of the presentities;
calculating respective distances between the presentities using the location information;
forming a location based presence group for a watcher one of the presentities, the location based presence group including the ones of the presentities whose calculated distance from the watcher is less than a configurable proximity metric; and
providing the watcher with the presence information of the presentities within the location based presence group.

2. The method of claim 1, wherein the step of forming further comprises:
identifying the ones of the presentities that have subscribed to a location based presence service; and
forming the location based presence group from the ones of the presentities that subscribed to the location based presence service.

3. The method of claim 2, wherein the step of identifying further comprises:
prompting at least one of the presentities to subscribe to the location based presence service based on the current geographical location of the at least one presentity.

4. The method of claim 1, wherein the step of providing further comprises:
transmitting the presence information of the presentities within the location based presence group to a presence client running on a terminal associated with the watcher for display thereon.

5. The method of claim 1, wherein the step of providing further comprises:
filtering the presence information of the presentities within the location based presence group to produce filtered presence information; and
providing the filtered presence information to the watcher.

6. The method of claim 5, wherein the step of filtering further comprises:
determining preference information associated with the watcher, the preference information indicating a portion of the presence information associated with the presentities that the watcher would like to receive; and
filtering the presence information of the presentities within the location based presence group using the preference information to produce the filtered presence information.

7. The method of claim 5, wherein the step of filtering further comprises:
determining preference information associated with at least one of the presentities, the preference information indicating a portion of the presence information associated with the at least one of the presentities that the watcher can receive; and
filtering the presence information of the presentities within the location based presence group using the preference information to produce the filtered presence information.

8. The method of claim 1, wherein the step of providing further comprises:
providing a partial location based presence group to the watcher, the partial location based presence group representing changes to the location based presence group based on a previous location based presence group, the changes including added ones and removed ones of the presentities.

9. The method of claim 8, further comprising:
receiving a request to subscribe to the presence information of each of the added ones of the presentities from the watcher; and
receiving a request to unsubscribe to the presence information of each of the removed ones of the presentities from the watcher.

10. The method of claim 1, further comprising:
configuring the configurable proximity metric based on the current geographic location of the watcher or the preferences of the watcher.

11. A presence system, comprising;
a presence server operable to maintain presence information for a plurality of presentities, the presence information including contact information for and availability in one or more media types of the presentities and location information identifying a respective current geographical location of each of the presentities, the presence server further being operable to provide the presence information of the presentities within a location based presence group to a watcher one of the presentities; and
a proximity presence group application coupled to the presence server and operable to calculate respective distances between the presentities using the location information and form the location based presence group for the watcher, the location based presence group including the ones of the presentities whose calculated distance from the watcher is less than a configurable proximity metric.

12. The presence system of claim 11, wherein the presence server is coupled to a location system that determines the location information of the presentities and provides the location information thereto.

13. The presence system of claim 11, wherein the presence server is further operable to identifying the ones of the presentities that have subscribed to a location based presence service and to provide the location information of the ones of the presentities that subscribed to the location based presence service to the proximity presence group application.

14. The presence system of claim 13, wherein the presence server is further operable to prompt at least one of the presentities to subscribe to the location based presence service based on the current geographical location of the at least one presentity.

15. The presence system of claim 11, wherein the presence server is further operable to transmit the presence information of the presentities within the location based presence group to a presence client running on a terminal associated with the watcher for display thereon.

16. The presence system of claim 11, wherein the presence server is further operable to filter the presence information of the presentities within the location based presence group to produce filtered presence information and to provide the filtered presence information to the watcher.

17. The presence system of claim 16, wherein the presence server is further operable to determine preference information associated with the watcher, the preference information indicating a portion of the presence information associated with the presentities that the watcher would like to receive, and to filter the presence information of the presentities within the location based presence group using the preference information to produce the filtered presence information.

18. The presence system of claim 16, wherein the presence server is further operable to determine preference information associated with at least one of the presentities, the preference information indicating a portion of the presence information associated with the at least one of the presentities that the watcher can receive, and to filter the presence information of the presentities within the location based presence group using the preference information to produce the filtered presence information.

19. The presence system of claim 11, wherein the presence server is further operable to provide a partial location based presence group to the watcher, the partial location based presence group representing changes to the location based presence group based on a previous location based presence group, the changes including added ones and removed ones of the presentities.

20. The presence server of claim 19, wherein the presence server is further operable to receive a request to subscribe to the presence information of each of the added ones of the presentities from the watcher and to receive a request to unsubscribe to the presence information of each of the removed ones of the presentities from the watcher.
